(19) United States
(12) Patent Application Publication
(10) Pub. No.: US 2006/0102204 A1
(43) Pub. Date: May 18, 2006

(54) Method for removing a residue from a substrate using supercritical carbon dioxide processing

(75) Inventors: Gunilla Jacobson, Palo Alto, CA (US); Bentley Palmer, Phoenix, AZ (US); Shan C. Clark, Forest Grove, OR (US); Vijayakumar S. Ramachandrarao, Portland, OR (US); Subramanyam A. Iyer, Santa Clara, CA (US); Robert Turkot, Hillsboro, OR (US)

Correspondence Address: WOOD, HERRON & EVANS, LLP (TOKYO ELECTRON), 2700 CAREW TOWER, 441 VINE STREET, CINCINNATI, OH, 45202, US

(73) Assignees: Tokyo Electron Limited; Intel Corporation

(21) Appl. No.: 10/987,594

(22) Filed: Nov. 12, 2004

(51) Int. Cl. C23G 1/00; B08B 3/00

(52) U.S. Cl. 134/26; 134/2

(57) ABSTRACT

A method for cleaning a substrate containing a micro-feature having a residue thereon. The method includes treating the substrate with a supercritical carbon dioxide cleaning solution containing a peroxide to remove the residue from the micro-feature, where the supercritical carbon dioxide cleaning solution is maintained at a temperature between about 35° C. and about 80° C. According an embodiment of the invention, the supercritical carbon dioxide cleaning solution can further contain ozone. According to another embodiment of the invention, the substrate can be pre-treated with an ozone processing environment.

### CROSS REFERENCE TO RELATED APPLICATIONS

The present invention is related to U.S. patent application Ser. No. ______, entitled SYSTEM FOR REMOVING A RESIDUE FROM A SUBSTRATE USING SUPERCRITICAL CARBON DIOXIDE PROCESSING and filed on even date herewith, the entire content of which is herein incorporated by reference. The related application is not commonly owned.

### FIELD OF THE INVENTION

The present invention relates to the field of substrate processing. More particularly, the present invention relates to removal of residue from a micro-feature on a substrate using supercritical carbon dioxide processing.

### BACKGROUND OF THE INVENTION

Plasma processing systems are used in the manufacture and processing of semiconductors, integrated circuits, micro-electro mechanical systems (MEMS), displays, and other devices or materials to both remove material from and deposit materials on a substrate. Plasma processing of semiconductor substrates to transfer a pattern of an integrated circuit from a photolithographic mask to the substrate, or to deposit dielectric or conductive films on the substrate, has become a standard method in the industry. Furthermore, the drive to reduce the minimum feature sizes of microelectronic devices to meet the demand for faster, lower power microprocessors and digital circuits has introduced new materials and processes into device manufacturing. These new materials include low dielectric constant (low-k) materials, ultra-low-k (ULK) materials, and porous dielectric materials, which tend to be less chemically robust than more traditional oxide and nitride dielectric layers.

In semiconductor processing, where various types of films are etched, integration challenges and trade-offs still remain. Conventionally, a dielectric layer is patterned with openings for depositing conductive materials to form vertical contacts. During the patterning process, an etch resistant photoresist layer and/or a hard mask layer is deposited over the dielectric layer, exposed to a selected pattern and developed. The layered structure is then etched in a plasma environment where the patterned photoresist layer defines openings in the dielectric layer. An ion implantation process is another example of a process that utilizes a photoresist to mask areas of a semiconductor substrate.

Halocarbon gases are commonly used in the plasma etching of dielectric materials. These gases are known to generate fluorocarbon polymer etch residues during the dielectric etch process. Following the etch process, photoresist remnants and etch residues, both of which are referred to herein as post-etch residues, are frequently observed on the micro-features and chamber surfaces. In the case of carbon-containing dielectric layers, the etch residues can contain a crust with very high carbon content.

A plasma ashing process to remove post-etch residues is commonly followed by wet processing using cleaning chemicals to further clean the residues from the micro-features. Wet processing usually includes the use of water as a carrier of the cleaning chemicals to the micro-features. In the case of carbon-containing low-k dielectric materials, an oxygen ashing process can reduce the carbon content and increase the dielectric constant of the materials. In addition, wet processing of porous dielectric layers can leave moisture and cleaning materials in the pores, which in turn can increase the dielectric constant of the layers.

There has been a significant amount of activity in developing alternative methods and systems for cleaning substrates and removing processing residues, especially post-etch residues. One technology that shows a great potential towards achieving this goal is supercritical fluid technology. Methods and systems for cleaning post-etch residues from substrates using supercritical processing have been described in U.S. Pat. Nos. 6,500,605 and 6,509,141, both of which are hereby incorporated by reference. While supercritical processing provides a promising alternative to ashing and wet processing for removing post-etch residues from wafer substrates, there is still a need to develop improved supercritical fluid processing systems and methods that can be used to reduce the time and/or steps required to clean the substrates and to address the requirements of new materials used for patterning the substrates.

### SUMMARY OF THE INVENTION

The present invention is directed to a method for removing a residue from a micro-feature on a substrate. By way of example, the residue can be a post-etch residue, including polymer etch residue, photoresist remnants, anti-reflective coatings and other materials used for patterning a substrate.

According to an embodiment of the invention, the method includes providing the substrate containing a micro-feature having a residue thereon, and treating the substrate with a supercritical carbon dioxide cleaning solution containing a peroxide to remove the residue from the micro-feature, where the supercritical carbon dioxide cleaning solution is maintained at a temperature between about 35° C. and about 80° C. According to a further embodiment of the invention, the method includes pre-treating the substrate with an ozone processing environment prior to treating the substrate with the supercritical carbon dioxide cleaning solution. According to yet a further embodiment of the invention, the treating can be performed in a supercritical fluid processing system and the pre-treating can be performed in an ozone processing system that is operatively coupled to the supercritical fluid processing system. Alternatively, the pre-treating and the treating can both be performed in the supercritical fluid processing system.

According to another embodiment of the invention, the method includes providing the substrate in a process chamber, the substrate containing a micro-feature having a residue thereon, generating ozone in the process chamber, forming a supercritical cleaning solution containing supercritical carbon dioxide and ozone, and treating the substrate with the supercritical cleaning solution to remove the residue from the micro-feature, where the supercritical cleaning solution is maintained at a temperature between about 35° C. and about 80° C.

According to yet another embodiment of the invention, the method can further include rinsing the substrate with a supercritical carbon dioxide rinse solution containing an organic solvent.

### BRIEF DESCRIPTION OF THE DRAWINGS

In the accompanying drawings:

FIGS. 1A and 1B show a cross-sectional view of a process for removing a post-etch residue from a micro-feature on a substrate in accordance with an embodiment of the invention;

FIG. 2 shows an ozone processing system in accordance with an embodiment of the present invention;

FIG. 3A shows a simplified schematic diagram of a film removal system containing an ozone generator operatively coupled to a supercritical fluid processing system in accordance with an embodiment of the invention;

FIG. 3B shows a simplified schematic diagram of a film removal system containing a supercritical fluid processing system having an ozone generator in accordance with another embodiment of the invention;

FIG. 4 is a plot of pressure versus time for a supercritical cleaning and rinsing process in accordance with an embodiment of the invention; and

FIG. 5 is a flow diagram for removing a residue from a micro-feature on a substrate in accordance with an embodiment of the invention.

### DETAILED DESCRIPTION OF SEVERAL EMBODIMENTS OF THE INVENTION

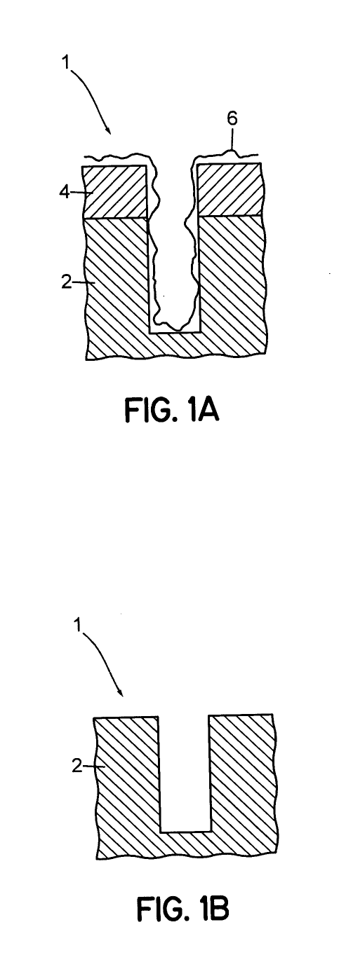

The term micro-feature, as used herein, refers to a feature formed in a substrate and/or in a layer or layers formed on a substrate that has a dimension on the micrometer scale, and typically the sub-micron scale, i.e., less than 1 μm. The micro-feature can, for example, contain high-aspect ratio trenches and/or vias with lateral dimensions in the sub-micron or deep sub-micron regime and vertical dimensions up to several microns. FIGS. 1A and 1B show a cross-sectional view of a process for removing a residue from a micro-feature on a substrate in accordance with an embodiment of the invention. In FIG. 1A, the micro-feature 1 contains a substrate 2, a photoresist layer 4, and a post-etch residue 6. The post-etch residue 6 coats sidewalls and other surfaces of the micro-feature 1 and can, for example, contain a fluorocarbon polymer etch-deposit and hardened photoresist from plasma etching of the micro-feature 1. FIG. 1B shows the micro-feature 1 following removal of the post-etch residue 6 and the photoresist layer 4 in a cleaning process according to embodiments of the invention.

The micro-feature 1 in FIG. 1A can further contain additional layers including hardmasks and anti-reflective coatings (ARC) (not shown) when high-resolution line widths and high feature aspect ratios are required. The anti-reflective coating can be a nitride layer, including a titanium nitride (TiN) layer or a silicon nitride layer (SiN), which may become part of the transistor. Because nitrides are high dielectric constant (k) materials, they are not well suited for use as anti-reflective coatings on low-k materials, as the high dielectric properties of a nitride layer can dominate the electrical properties of the device. Accordingly, a silicon oxide-based ARC can be used, wherein the silicon oxide ARC can be removed from the low-k material in a post-etch cleaning process. However, removing these additional materials along with the post-etch residues, such as described above, can create new challenges.

Embodiments of the present invention are well suited for removing post-etch polymers and/or polymeric ARC layers from micro-features containing porous and/or low-k silicon oxide-based layers. Low-k silicon oxide-based layers include low-k layers formed of materials exhibiting low dielectric constants of between 3.5-2.5. Silicon oxide-based materials include a number of low-k materials that contain silicon oxide and hydrocarbon components. These carbon-containing dielectric materials include SiCOH materials. Embodiments of the present invention can also be applied to removing residues from a substrate doped through a photoresist mask using techniques such as ion implantation, where inorganic contaminants can become embedded in the photoresist mask, thereby changing the physical characteristics and the composition of the photoresist mask and making removal of the photo-resist mask more difficult.

While the present invention is described in relation to applications for removing post-etch residues typically used in wafer patterning processes, it will be clear to one skilled in the art that the present invention can be used to remove any number of different residues (including polymers and oils) from any number of different materials (including silicon nitrides) and structures, including micro-mechanical, micro-optical, micro-electrical structures, and combinations thereof.

Thus, according to one embodiment of the invention, a method is provided for cleaning a substrate in a film removal system, where the method includes providing a substrate containing a micro-feature having a residue thereon, and treating the substrate with a supercritical carbon dioxide cleaning solution containing a peroxide to remove the residue from the micro-feature, where the supercritical carbon dioxide cleaning solution is maintained at a temperature between about 35° C. and about 80° C.

The method may further include pre-treating the substrate with an ozone processing environment prior to treating the substrate with the supercritical carbon dioxide cleaning solution. When the substrate is pre-treated with an ozone-processing environment, at least a portion of the residue can react with the ozone and form reaction products that are removed from the micro-feature. The ozone processing environment can further modify any remaining residue on the micro-feature. This includes chemically modifying photoresist remnants that were hardened by an earlier plasma etch process, thereby enabling removal of the residue by the supercritical carbon dioxide cleaning solution.

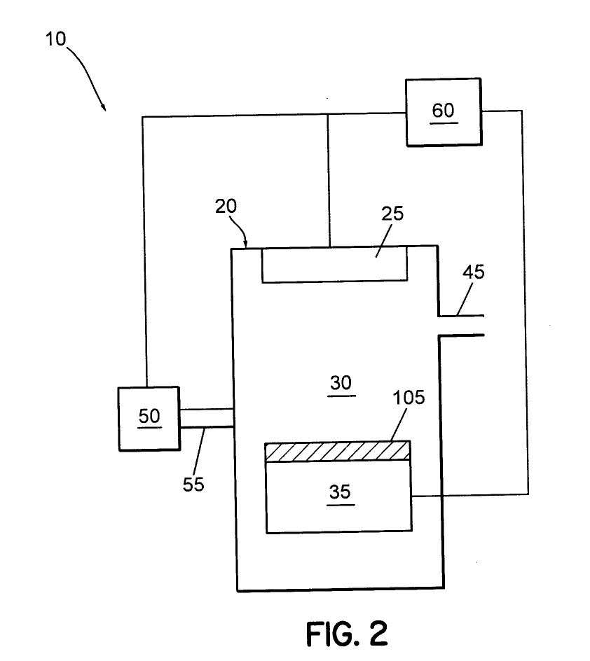

FIG. 2 shows an ozone processing system in accordance with an embodiment of the present invention. The ozone processing system 10 contains a process chamber 20. Within the process chamber 20 is an ozone generator 25 for generating an ozone processing environment 30 to pre-treat a substrate 105 within the process chamber 20. Alternately, although not shown, the ozone generator 25 can be a remote ozone generator configured for generating ozone outside the process chamber 20 and flowing ozone into the process chamber 20. One example of a remote ozone generator is a Series OG-5000-A Ozone Generator, manufactured by IN USA, Needham, Mass., USA. The Series OG-5000-A Ozone Generator is capable of an output of up to 210 g of ozone per hour, where the oxygen gas flow rate can be between about 0.5 standard liters per minute (sipm) and about 20 sipm at a gas pressure of 15-40 pounds per square inch gauge (psig). In one embodiment of the invention, the ozone processing environment can contain a process chamber pressure of between about 5 psig and about 100 psig. Alternately, the process chamber pressure can be between about 15 psig and about 40 psig. In one embodiment of the invention, the ozone concentration in the oxygen gas in the ozone processing environment 30 can be between about 5% and about 15% by volume.

In one embodiment of the invention, the substrate 105 can be a silicon substrate containing etched micro-features with post-etch residues thereon, as explained above. In general, the substrate can include a semiconductor material, a metallic material, a dielectric material, a ceramic material, or a polymer material, or a combination of two or more thereof. The semiconductor material can, for example, include Si, Ge, Si/Ge, or GaAs. The metallic material can, for example, include Cu, Al, Ni, Ru, Ti, or Ta. The dielectric material can, for example, include SiO₂, SiON, SiCOH, Ta₂O₅, TiO₂, ZrO₂, Al₂O₃, Y₂O₃, HfSiOₓ, HfO₂, ZrSiOₓ, TaSiOₓ, SrOₓ, SrSiOₓ, LaOₓ, LaSiOₓ, YOₓ, or YSiOₓ. The ceramic material can, for example, include AlN, SiC, BeO, or LaB₆. The substrate 40 can be of any size, for example a 200 mm substrate, a 300 mm substrate, or an even larger substrate. As would be appreciated by those skilled in the art, other semiconductor materials, metallic materials, dielectric materials, and ceramic materials may be employed without departing from the scope of the invention.

The ozone process chamber 20 is also equipped with a stage or chuck 35 for supporting and holding the substrate 105 while the substrate 105 is pre-treated by exposing it to the ozone processing environment 30. The stage or chuck 35 can also be configured to heat or cool the substrate 105 before, during and/or after exposing the substrate 105 to the ozone processing environment 30. In one embodiment of the invention, the substrate temperature can be between about 20° C. and about 400° C., during exposure to the ozone processing environment 30. In another embodiment of the invention, the substrate temperature can be between about 60° C. and about 200° C. Generally, the rate of reaction between a residue and an ozone processing environment increases with substrate temperature. However, care must be taken when pre-treating substrates with the ozone processing environment 30, since many dielectric materials, in particular low dielectric constant (k) or porous dielectric materials, can be damaged if the substrate temperature is too high during the ozone pre-treating process. In one embodiment of the invention, the substrate can be pre-treated for a time period between about 10 sec and about 1200 sec. In another embodiment of the invention, the substrate can be pre-treated for a time period between about 30 sec and about 300 sec.

Still referring to FIG. 2, the ozone processing system 10 is equipped with a gas source 50, where the gas source 50 can contain oxygen or an oxygen-containing gas. The gas source 50 is coupled to the process chamber 20 through a gas inlet line 55. The processing system 10 also includes an outlet line 45 for exhausting ozone from the process chamber 20. It will be clear to one skilled in the art that the ozone processing system 10 can be configured with any number of valves and/or regulators (not shown) for isolating the ozone processing environment 30 within the process chamber 20 and/or flow meters and pressure gauges (not shown) for measuring and controlling a flow of gas and/or ozone through the ozone process chamber 20. Furthermore, the ozone processing system 10 contains a controller 60 for controlling the components of the ozone processing system 10. According to an embodiment of the invention, after the substrate 105 has been pre-treated by exposure to the ozone processing environment 30, the substrate 105 is cleaned and/or rinsed with one or more supercritical carbon dioxide cleaning solutions in a supercritical fluid process chamber.

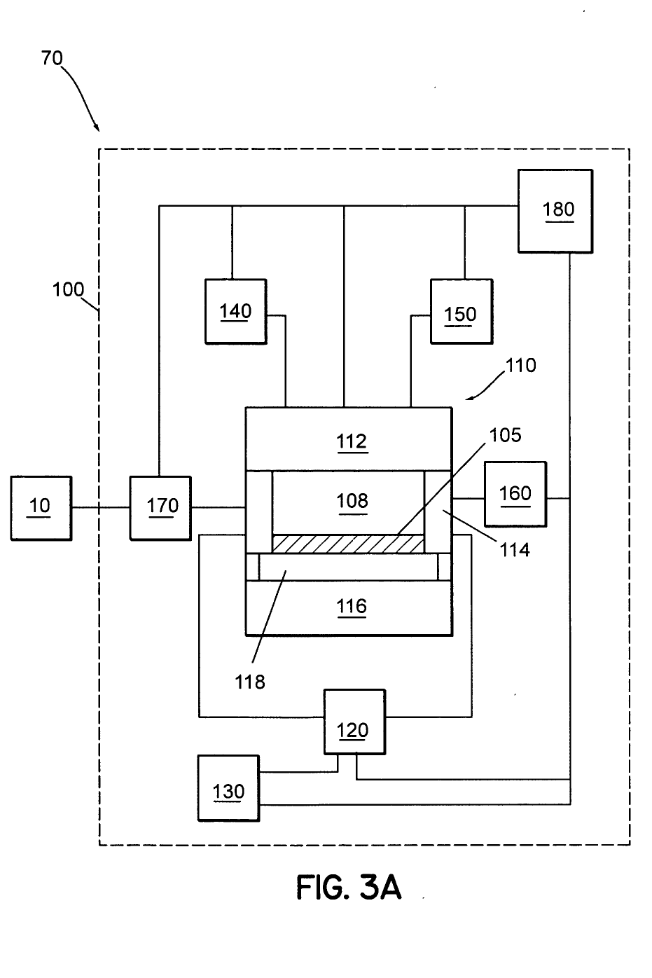

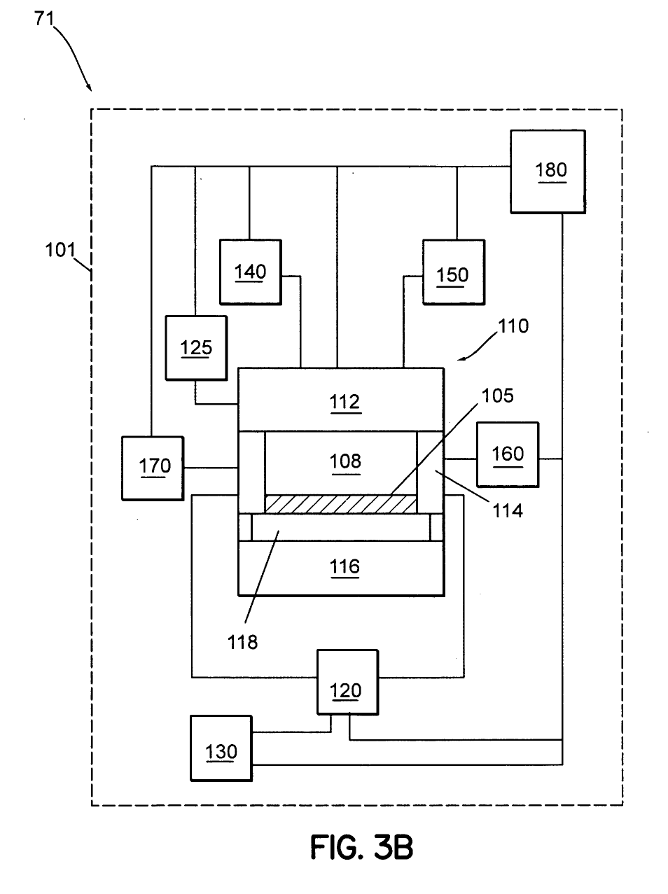

FIG. 3A shows a simplified schematic of a film removal system 70 containing an ozone generator 10 operatively coupled to a supercritical fluid processing system 100 in accordance with an embodiment of the invention. The ozone processing system 10 depicted in FIG. 3A can, for example, be the ozone processing system 10 described in FIG. 2. The film removal system 70 contains a supercritical fluid processing system 100 that is operatively coupled to the ozone processing system 10 through a (robotic) substrate transfer system 170 containing one or more isolation chambers (not shown). The substrate transfer system 170 can be used to move the substrate 105 in and out of the process chamber 108 of a processing module 110 through a slot (not shown). In one example, the slot can be opened and closed by moving the chuck 118, and in another example, the slot can be controlled using a gate valve (not shown). Alternatively, any other suitable means can be utilized for transferring a substrate 105 from the ozone processing system 10 to the supercritical fluid processing system 100 without exposing the substrate 105 to the outside environment. In another alternative, the substrate 105 can be transferred from the ozone processing system 10 to the supercritical fluid processing system 100 during which it is exposed to the outside environment.

Details of processing equipment that have multiple process chambers, including at least one supercritical fluid process chamber, are described in U.S. Pat. No. 6,748,966, the contents of which is hereby incorporated by reference.

In FIG. 3A, the supercritical fluid processing system 100 further includes a circulation system 120, a chemical supply system 130, a carbon dioxide supply system 140, a pressure control system 150, an exhaust system 160, and a controller 180. The controller 180 can be coupled to the processing module 110, the circulation system 120, the chemical supply system 130, the carbon dioxide supply system 140, the pressure control system 150, the exhaust system 160, and the substrate transfer system 170. Alternately, the controller 180 can be coupled to one or more additional controllers/computers (not shown), and the controller 180 can obtain setup and/or configuration information from an additional controller/computer.

In FIG. 3A, singular processing elements (110, 120, 130, 140, 150, 160, 170, and 180) are shown, but this is not required for the invention. The supercritical fluid processing system 100 can include any number of processing elements having any number of controllers associated with them in addition to independent processing elements. The controller 180 can be used to configure any number of processing elements (110, 120, 130, 140, 150, 160, and 170), and the controller 180 can collect, provide, process, store, and display data from the processing elements. The controller 180 can comprise a number of applications for controlling one or more of the processing elements. For example, controller 180 can include a GUI (graphic user interface) component (not shown) that can provide easy to use interfaces that enable a user to monitor and/or control one or more processing elements.

The processing module 110 can include an upper assembly 112, a frame 114, and a lower assembly 116. The upper assembly 112 can comprise a heater (not shown) for heating the process chamber 108, the substrate 105, or the supercritical carbon dioxide fluid, or a combination of two or more thereof. Alternately, a heater is not required. The frame 114 can include means for flowing a supercritical carbon dioxide fluid through the process chamber 108. In one example, a circular flow pattern can be established in the process chamber 108; and in another example, a substantially linear flow pattern can be established in the process chamber 108. Alternately, the means for flowing a processing fluid in the process chamber 108 can be configured differently. The lower assembly 116 can comprise one or more lifters (not shown) for moving the chuck 118 and/or the substrate 105. Alternately, a lifter is not required.

In one embodiment, the processing module 110 includes a holder or chuck 118 for supporting and holding the substrate 105 while processing the substrate 105. The stage or chuck 118 can also be configured to heat or cool the substrate 105 before, during, and/or after processing the substrate 105. Alternately, the processing module 110 can include a platen (not shown) for supporting and holding the substrate 105 while processing the substrate 105. Like the ozone processing system 10, the process chamber 108 can process a substrate 105 of any size, for example a 200 mm substrate, a 300 mm substrate, or an even larger substrate.

The circulation system 120 can comprise one or more valves for regulating the flow of a supercritical processing solution through the circulation system 120 and through the processing module 110. The circulation system 120 can comprise any number of back-flow valves, filters, pumps, and/or heaters (not shown) for maintaining and flowing a supercritical carbon dioxide solution through the circulation system 120 and through the processing module 110. Carbon dioxide fluid is in a supercritical state when above the critical temperature T_{c} of about 31° C. and the critical pressure P_{c} of about 1,070 psig. Supercritical carbon dioxide fluid has virtually no viscosity or surface tension and has therefore no difficulty in penetrating all the way to the bottom of a micro-feature to remove a residue from the micro-feature. In one embodiment of the invention, the temperature of the supercritical carbon dioxide fluid in the process chamber 108 can be between about 35° C. and about 80° C. Alternately, the temperature of the carbon dioxide fluid in the process chamber 108 can be between about 60° C. and about 70° C.

The processing system 100 can contain a carbon dioxide supply system 140. As shown in FIG. 3A, the carbon dioxide supply system 140 can be coupled to the processing module 110, but this is not required. In alternate embodiments, the carbon dioxide supply system 140 can be configured differently and coupled differently. For example, the carbon dioxide supply system 140 can be coupled to the circulation system 120.

The carbon dioxide supply system 140 can contain a carbon dioxide source (not shown) and a plurality of flow control elements (not shown) for controlling delivery of carbon dioxide fluid to the process chamber 108. For example, the carbon dioxide source can include a carbon dioxide feed system, and the flow control elements can include supply lines, valves, filters, pumps, and heaters. The carbon dioxide supply system 140 can comprise an inlet valve (not shown) that is configured to open and close to allow or prevent the stream of carbon dioxide from flowing into the process chamber 108. For example, controller 180 can be used to determine fluid parameters including pressure, temperature, process time, and flow rate.

In the illustrated embodiment in FIG. 3A, the chemical supply system 130 is coupled to the circulation system 120, but this is not required for the invention. In alternate embodiments, the chemical supply system 130 can be configured differently and can be coupled to different elements in the processing system 100. The chemical supply system 130 can comprise a cleaning chemical assembly (not shown) for providing a cleaning chemical for generating a supercritical carbon dioxide cleaning solution within the process chamber 108. The cleaning chemical includes a peroxide. The peroxide can, for example, contain hydrogen peroxide or an organic peroxide. The organic peroxide can, for example, include 2-butanone peroxide, 2,4-pentanedione peroxide, peroxyacetic acid, benzoyl peroxide, t-butyl hydroperoxide, m-chloroperbenzoic acid, or any other suitable peroxide. The cleaning chemical can further contain an acid. The acid can, for example, contain hydrogen fluoride, trifluoroacidic acid, pyridine-hydrogen fluoride, ammonium fluoride, nitric acid, or phosphoric acid, or a combination of two or more thereof. As may be appreciated by those skilled in the art, other peroxides and acids may be employed without departing from the scope of the invention.

Further details of fluoride sources and methods of generating supercritical fluid processing solutions containing fluorine are described in U.S. patent application Ser. No. 10/442,557, filed May 20, 2003, and titled “TETRA-ORGANIC AMMONIUM FLUORIDE AND HF IN SUPERCRITICAL FLUID FOR PHOTORESIST AND RESIDUE REMOVAL”, and U.S. patent application Ser. No. 10/321,341, filed Dec. 16, 2002, and titled “FLUORIDE IN SUPERCRITICAL FLUID FOR PHOTORESIST POLYMER AND RESIDUE REMOVAL,” both of which are hereby incorporated by reference.

In addition, the cleaning chemical can include chelating agents, complexing agents and other oxidants, organic and inorganic acids that can be introduced into supercritical carbon dioxide with one or more carrier solvents, including N,N-dimethylacetamide (DMAC), gamma-butyrolacetone (BLO), dimethyl sulfoxide (DMSO), ethylene carbonate (EC), N-methylpyrrolidone (NMP), dimethylpiperidone, propylene carbonate, or alcohols (e.g., methanol, ethanol, or 2-propanol), or a combination of two or more thereof. As may be appreciated by those skilled in the art, other solvents may be employed without departing from the scope of the invention.

The chemical supply system 130 can furthermore provide a rinsing chemical for generating supercritical carbon dioxide rinsing solutions within the process chamber 108. The rinsing chemical can include one or more organic solvents including, but not limited to, alcohols, ketones, or both. In one embodiment of the invention, the organic solvent can contain methanol, ethanol, n-propanol, isopropanol, benzyl alcohol, acetone, butylene carbonate, propylene carbonate, dimethylsulfoxide, γ-butyrolactone, dimethyl formamide, dimethyl acetamide, or ethyl lactate, or a combination of two or more thereof. As may be appreciated by those skilled in the art, other organic solvents may be employed without departing from the scope of the invention.

The processing system 100 can also comprise a pressure control system 150. As shown in FIG. 3A, the pressure control system 150 can be coupled to the processing module 110, but this is not required. In alternate embodiments, pressure control system 150 can be configured differently and coupled differently. The pressure control system 150 can include one or more pressure valves (not shown) for regulating the pressure within the process chamber 108. Alternately, the pressure control system 150 can also include one or more pumps (not shown). For example, one pump may be used to increase the pressure within the process chamber, and another pump may be used to evacuate the process chamber 108. In another embodiment, the pressure control system 150 can comprise means for sealing the process chamber. In addition, the pressure control system 150 can comprise means for raising and lowering the substrate 105 and/or the chuck 118.

Furthermore, the processing system 100 can comprise an exhaust system 160. As shown in FIG. 3A, the exhaust system 160 can be coupled to the processing module 110, but this is not required. In alternate embodiments, exhaust system 160 can be configured differently and coupled differently. The exhaust system 160 can include an exhaust gas collection vessel (not shown) and can be used to remove contaminants from the processing fluid. Alternately, the exhaust system 160 can be used to recycle the processing fluid.

Controller 180 can be used to feed forward and/or feed back information. For example, feed-forward information can comprise pre-process data associated with an in-coming substrate. This pre-process data can include lot data, batch data, run data, composition data that includes type of photoresist used, type of substrate, type of layers overlying the substrate, and history data including, for example, type of process gases used in a prior etch process. The pre-process data can be used to establish an input state for a substrate. The controller 180 can use the difference between an input data item for an incoming substrate (input state) and a desired data item (desired state) to predict, select, or calculate a set of process parameters to achieve the desired result of changing the state of the substrate from the input state to the desired state. The desired state can, for example, indicate the level of substrate cleanliness following a cleaning process and/or a rinse process. For example, this predicted set of process parameters can be a first estimate of a recipe to use based on an input state and a desired state. In one embodiment, data such as the input state and/or the desired state data can be obtained from a host.

In one example, the controller 180 knows the input state and a model equation for the desired state for the substrate, and the controller determines a set of recipes that can be performed on the substrate to change the status of the substrate from the input state to a desired state. For example, the set of recipes can describe a multi-step process involving a set of process systems. For example, post-process metrology data can be obtained to evaluate the state of the substrate, i.e., if the residue has been sufficiently removed from the substrate. Post-process metrology data can be obtained after a time delay that can vary from minutes to days. Post-process metrology data can be used as a part of the feedback control.

The controller 180 can compute a predicted state for the wafer based on the input state, the process characteristics, and a process model. For example, a cleaning rate model can be used along with a contaminant level to compute a predicted cleaning time. Alternately, a rinse rate model can be used along with a contaminant level to compute a processing time for a rinse process. The controller 180 can comprise a database component (not shown) for storing input and output data. Process models can include linear models, quadratic models, full quadratic models, and higher order polynomial models. A process model can provide the relationship between one or more process recipe parameters or setpoints and one or more process results and can include multiple variables.

In a supercritical cleaning/rinsing process, the desired process result can be a process result that is measurable using an optical measuring device. For example, the desired process result can be an amount of contaminant (e.g., residue) on a micro-feature. After each cleaning process run, an actual process result can be measured and compared to a desired process result to determine process compliance. After each cleaning process run, the actual process results can be determined, and a system of equations can be created to solve for the coefficients in the model equation.

In general, process control can include updating a process module recipe using metrology information measured on the substrate prior to its arrival in the process module 110. For a cleaning process, the incoming substrates should all be the same, with the same pre-processing data. The controller can use the pre-processing data to verify that all of the substrates used in a group are the same. The process of creating the process models requires an understanding of the mechanics of experimental design, execution of an appropriate experiment and analysis of the resultant experimental data. This process can be highly automated and integrated into the film removal system 70 using the technique described herein.

FIG. 3B shows a simplified schematic diagram of a film removal system 71 containing a supercritical fluid processing system 101 having an ozone generator 125 in accordance with another embodiment of the invention. The supercritical fluid portion of the supercritical fluid processing system 101 can be the same or similar to the supercritical fluid processing system 100 of FIG. 3A, i.e., it can include all components shown in FIG. 3A. In FIG. 3B, the supercritical fluid processing system 101 contains an ozone generator 125 for generating an ozone processing environment in the process chamber 108. The ozone generator 125 can further include a gas source containing oxygen or an oxygen-containing gas (not shown). The controller 180 can be used to configure and control the ozone generator 125 to generate an ozone processing environment in the process chamber 108.

In operation, the ozone generator 45 generates ozone that enters into the process chamber 108, where the substrate 105 is exposed to the ozone processing environment. In one embodiment of the invention, a continuous stream of ozone can be generated and used to pressurize the process chamber 108, or the ozone can flow through the process chamber 108 and exit the process chamber 108 through the exhaust system 160. After the ozone pre-treatment, the pre-treated residue can be removed from the substrate 105 using a supercritical carbon dioxide cleaning solution containing a peroxide. After the pre-treated residue has been removed from the substrate 105, the substrate can be treated with one or more supercritical rinsing solutions in the process chamber 108.

In another embodiment of the invention, an ozone pre-treatment can be omitted from the process and the substrate treated with a supercritical carbon dioxide cleaning solution containing a peroxide to remove a residue from the substrate.

In yet another embodiment of the invention, the process chamber 108 can be pressurized with ozone from the ozone generator 125, and a supercritical carbon dioxide cleaning solution containing ozone and a peroxide can be generated within the process chamber 108 to remove the residue from the substrate 105. An ozone pre-treatment may be included or omitted. After the residue has been removed from the substrate 105, the substrate 105 can be treated with one or more supercritical carbon dioxide rinsing solutions in the process chamber 108.

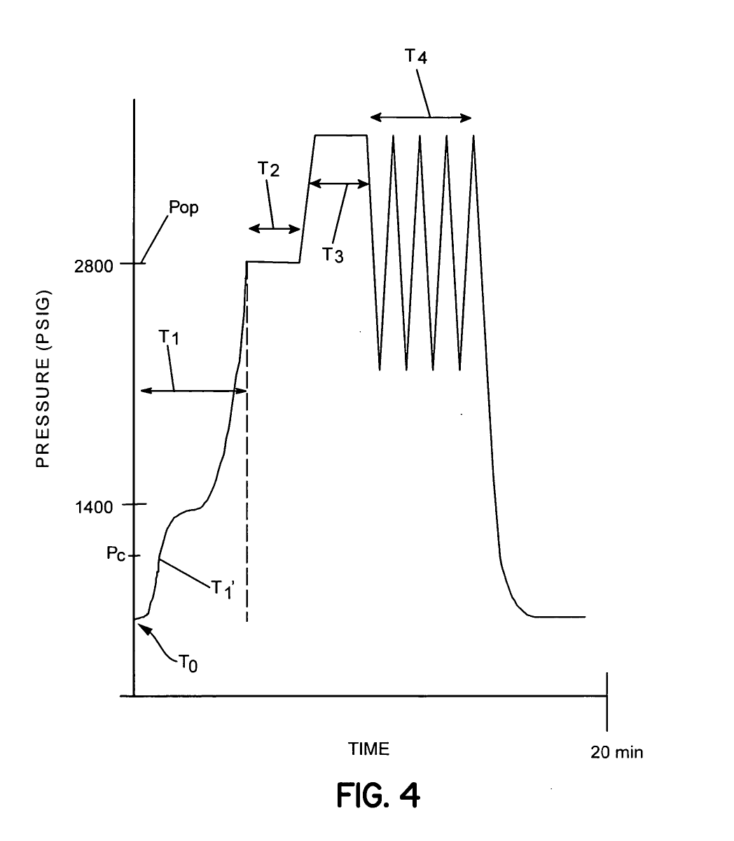

FIG. 4 is a plot of pressure versus time for a supercritical cleaning and rinsing process in accordance with an embodiment of the invention. In FIG. 4, a substrate having a residue on a micro-feature is placed in a supercritical fluid process chamber at an initial time T₀. The process chamber can, for example, be process chamber 108 of supercritical fluid processing systems 100 or 101 in FIG. 3A or 3B. During the time period T₁, the process chamber 108 is pressurized to generate a supercritical carbon dioxide fluid and to reach the desired operating pressure (Pₒₚ). When the carbon dioxide pressure within the process chamber 108 reaches or exceeds the critical pressure P_{c} (1,070 psig for carbon dioxide at 31° C.) at time T₁′, one or more cleaning chemicals can be injected into the process chamber 108 from chemical supply system 130. The cleaning chemical can, for example, include a peroxide and an acid, as described above. Several injections of cleaning chemicals can be performed to generate a supercritical carbon dioxide cleaning solution with the desired concentrations of cleaning chemicals. Alternately, the cleaning chemicals can be injected into the process chamber 108 after the time T₁′.

When the pressure within the process chamber 108 reaches an operating pressure Pₒₚ at the start of time period T₂, the supercritical carbon dioxide cleaning solution is circulated over and/or around the substrate 105 and through the process chamber 108 using the circulation system 120, such as described above. The operating pressure Pₒₚ can be any value as long as the pressure is sufficient to maintain supercritical fluid conditions and can, for example, be about 2,800 psig. The length of the time period T₂ can be selected to remove the desired amount of the residue from the substrate 105.

Next, a push-through process can be carried out during time period T₃, where a fresh stock of supercritical carbon dioxide fluid is fed into the process chamber 108 from the carbon dioxide supply system 140, thereby increasing the pressure in the process chamber 108. Furthermore, during the push-through process in period T₃, the supercritical carbon dioxide cleaning solution, along with any process residue suspended or dissolved therein, is simultaneously displaced from the process chamber 108 using the exhaust system 160.

The push-through process reduces the amount of particulates and contaminants that can fall-out from the supercritical carbon dioxide cleaning solution when its composition is altered by adding the fresh stock of supercritical carbon dioxide fluid. A number of methods for reducing fall-out of particles and contaminants using push-through techniques and/or pressurization techniques are described in U.S. patent application Ser. No. 10/338,524, filed Jan. 7, 2003, titled “METHOD FOR REDUCING PARTICULATE CONTAMINATION IN SUPERCRITCIAL FLUID PROCESSING”, and U.S. patent application Ser. No. 10/394,802, filed Mar. 21, 2003, titled “REMOVAL OF CONTAMINANTS USING SUPERCRITICAL PROCESSING”, both of which are hereby incorporated by reference in their entirety.

When the push-through step is complete at the end of time period T₃, a plurality of decompression and compression cycles can be performed in the process chamber 108 during time period T₄ to further remove contaminants from the substrate 105 and the supercritical fluid processing system. The decompression and compression cycles can be performed using the exhaust system 160 to lower the process chamber pressure to below the operating pressure Pₒₚ and then injecting fresh supercritical carbon dioxide fluid to raise the process chamber pressure to above the operating pressure Pₒₚ. The decompression and compression cycles allow the cleaning chemicals and any removed residue to be removed from the system before the next processing step. The supercritical cleaning steps are repeated as needed with the same or different cleaning chemicals. After a pre-determined number of the decompression and compression cycles are completed (four cycles are shown in FIG. 4), the process chamber 108 can be vented and exhausted to atmospheric pressure through the exhaust system 160. Thereafter, the substrate 105 can be removed from the process chamber 108 by the substrate transfer system 170 and the next substrate loaded into the process chamber 108. Alternately, the processed substrate 105 can be exposed to a supercritical carbon dioxide rinsing solution in the process chamber 108 before the substrate is removed from the process chamber 108.

The graph shown in FIG. 4 is provided for exemplary purposes only. It will be understood by those skilled in the art that a supercritical processing step can have any number of different time/pressures or temperature profiles without departing from the scope of the present invention. Furthermore, any number of cleaning and rinse processing sequences with each step having any number of compression and decompression cycles are contemplated. In addition, as stated previously, concentrations of various chemicals and species within a supercritical carbon dioxide cleaning solution can be readily tailored for the application at hand and altered at any time within a supercritical cleaning process.

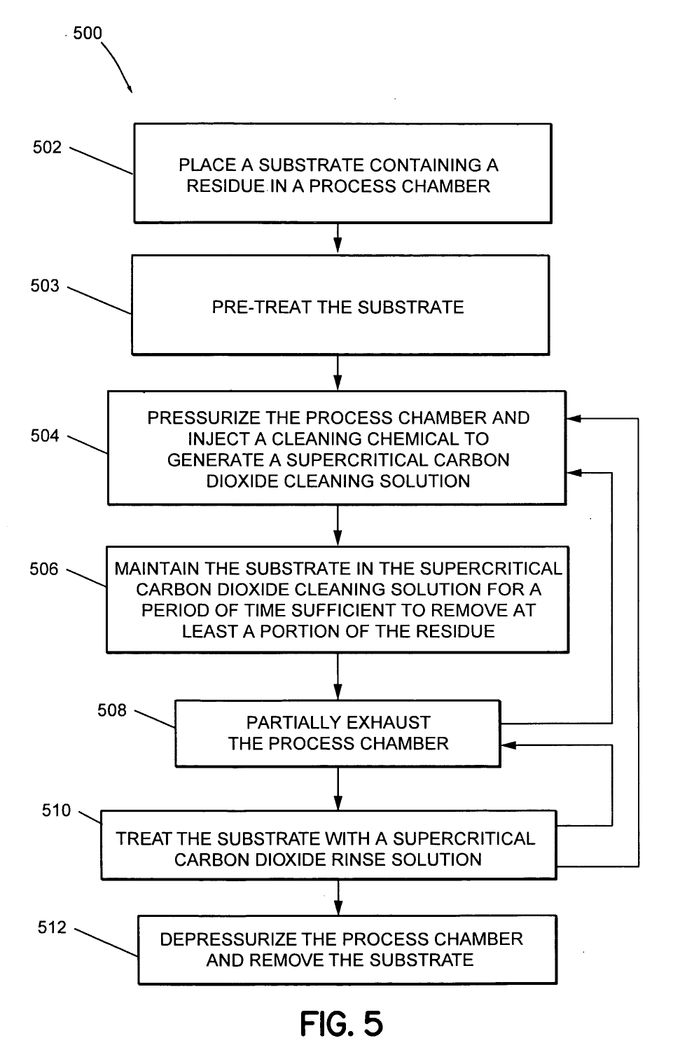

FIG. 5 is a flow diagram for removing a residue from a micro-feature on a substrate in accordance with an embodiment of the invention. The process 500 includes, in step 502, placing a substrate containing a residue in a process chamber. In one example, the micro-feature can comprise a patterned low-k layer with a photoresist residue and/or anti-reflective coating residue thereon. After the substrate is placed in the process chamber, the substrate is pre-treated with an ozone processing environment in step 503. As described above, the process chamber can be a process chamber of an ozone processing system or a process chamber of a supercritical fluid processing system. According to another embodiment of the invention, the pre-treating step 503 can be omitted from the process.

After the substrate is pre-treated with ozone, in step 504 carbon dioxide is added to the process chamber, which is then pressurized to generate supercritical carbon dioxide fluid, and a cleaning chemical containing a peroxide is added to the supercritical carbon dioxide fluid to generate a supercritical carbon dioxide cleaning solution. After the supercritical carbon dioxide cleaning solution is generated in step 504, the substrate is maintained in the supercritical carbon dioxide cleaning solution in step 506 for a period of time sufficient to remove at least a portion of the residue from the substrate, where the supercritical carbon dioxide cleaning solution is maintained at a temperature between about 35° C. and about 80° C. During the step 506, the supercritical carbon dioxide cleaning solution can be circulated through the process chamber and/or otherwise agitated to move the supercritical carbon dioxide cleaning solution over surfaces of the substrate.

Still referring to FIG. 5, after at least a portion of the residue is removed from the micro-feature in step 506, the process chamber is partially exhausted at 508. The steps 504-508 can be repeated any number of times required to remove a portion of the residue from the micro-feature, as indicated in the flow diagram. In accordance with embodiments of the invention, repeating steps 504 and 506 can use fresh supercritical carbon dioxide and fresh chemicals. Alternately, the concentration of the process chemicals in the supercritical carbon dioxide cleaning solution can be modified by diluting the cleaning solution with supercritical carbon dioxide, by adding additional charges of cleaning chemicals, or a combination thereof. By way of example only, the residue may be cleaned with a supercritical carbon dioxide fluid containing a peroxide. Alternately, the residue may be cleaned with a supercritical carbon dioxide fluid containing both a peroxide and an acid.

Still referring to FIG. 5, after the cleaning process or cycles containing steps 504-508 is complete, the substrate can be treated with a supercritical rinse solution in step 510. The supercritical carbon dioxide rinsing solution can contain supercritical carbon dioxide fluid and one or more organic solvents, for example an alcohol or a ketone, but can also be pure supercritical carbon dioxide. After the substrate is cleaned in the steps 504-508 and rinsed in the step 510, the process chamber is depressurized and the substrate is removed from the process chamber in step 512. Alternately, the substrate can be cycled through one or more additional cleaning/rinse processes comprising the steps 504-510, as indicated by the arrow connecting the steps 510 and 504 in the flow diagram. Alternately, or in addition to cycling the substrate through one or more additional cleaning/rinse cycles, the substrate can be treated to several rinse cycles prior to removing the substrate from the process chamber in step 512, as indicated by the arrow connecting the steps 510 and 508.

It will be clear to one skilled in the art that any number of different treatment sequences are within the scope of the invention. For example, cleaning steps and rinsing steps can be combined in any number of different ways to facilitate the removal of residue from a micro-feature. Furthermore, it may be appreciated by those skilled in the art that each of the steps or stages in the flowchart of FIG. 5 may encompass one or more separate steps and/or operations. Accordingly, the recitation of only seven steps in 502, 503, 504, 506, 508, 510, and 512 should not be understood to be limited solely to seven steps or stages. Moreover, each representative step or stage 502, 503, 504, 506, 508, 510, 512 should not be understood to be limited to only a single process.

### EXAMPLE

### Removal of Photoresist and Etch Residues From a Substrate

A substrate containing photoresist and etch residues on etched dielectric micro-features was cleaned according to embodiments of the invention. The substrate was cleaned using an ozone processing system operatively coupled to a supercritical fluid processing system as schematically shown in FIG. 3A. The substrate was exposed to an ozone processing environment for 4 min at a process chamber pressure around atmospheric pressure. Next, a supercritical carbon dioxide cleaning process was performed on the substrate for 5 min at a process pressure of 3,000 psig using a supercritical carbon dioxide cleaning solution containing 5 ml of 30% hydrogen peroxide (H₂O₂) and 10 ml of trifluoroacetic acid. Following the above cleaning process, the substrate was exposed for 2 min to a supercritical carbon dioxide rinse solution containing 20 ml of methanol (CH₃OH) at 3,000 psig.

Scanning electron microscope (SEM) images of the substrate showed complete removal of the photoresist and etch residues from the micro-features. The SEM images further showed the presence of polymer residue on the sidewalls of the micro-features. The polymer residue was subsequently fully removed by performing an additional cleaning step using a supercritical carbon dioxide cleaning solution containing 15 ml of dimethyl acetamide and 80 μl (microliters) of pyridine-HF at 3,000 psig. Following the additional cleaning step, the substrate was exposed for 2 min to a supercritical carbon dioxide rinse solution containing 20 ml of methanol (CH₃OH) at 3,000 psig.

While the present invention has been described in terms of specific embodiments incorporating details to facilitate the understanding of the principles of construction and operation of the invention, such references herein to specific embodiments and details thereof are not intended to limit the scope of the claims appended hereto. It will be apparent to those skilled in the art that modifications may be made in the embodiments chosen for illustration without departing from the scope of the invention.

What is claimed is:

1. A method of cleaning a substrate in a film removal system, the method comprising:
providing a substrate containing a micro-feature having a residue thereon; and
treating the substrate with a supercritical carbon dioxide cleaning solution containing a peroxide to remove the residue from the micro-feature, where the temperature of the carbon dioxide cleaning solution is maintained between about 35° C. and about 80° C.

2. The method according to claim 1, wherein the residue comprises a post-etch residue.

3. The method according to claim 2, wherein the post-etch residue comprises photoresist remnants and etch residues.

4. The method according to claim 1, wherein the micro-feature comprises a porous dielectric layer, a carbon-containing dielectric layer, or an ultra-low-k dielectric layer, or a combination of two or more thereof.

5. The method according to claim 4, wherein the carbon-containing dielectric layer comprises a SiCOH layer.

6. The method according to claim 1, wherein the supercritical carbon dioxide cleaning solution is maintained at a temperature between about 60° C. and about 70° C.

7. The method according to claim 1, wherein the peroxide comprises hydrogen peroxide or an organic peroxide.

8. The method according to claim 7, wherein the organic peroxide comprises 2-butanone peroxide, 2,4-pentanedione peroxide, peroxyacetic acid, benzoyl peroxide, t-butyl hydroperoxide, or m-chloroperbenzoic acid, or a combination of two or more thereof.

9. The method according to claim 1, wherein the supercritical carbon dioxide cleaning solution further comprises an acid.

10. The method according to claim 9, wherein the acid comprises hydrogen fluoride, trifluoroacidic acid, pyridine-hydrogen fluoride, ammonium fluoride, nitric acid, or phosphoric acid, or a combination of two or more thereof.

11. The method according to claim 1, further comprising:
rinsing the treated substrate with a supercritical carbon dioxide rinsing solution containing an organic solvent.

12. The method according to claim 11, wherein the organic solvent comprises an alcohol, a ketone, or both.

13. The method according to claim 12, where the organic solvent comprises methanol, ethanol, n-propanol, isopropanol, benzyl alcohol, acetone, butylene carbonate, propylene carbonate, dimethylsulfoxide, γ-butyrolactone, dimethyl formamide, dimethyl acetamide, or ethyl lactate, or a combination of two or more thereof.

14. The method according to claim 11, further comprising treating the rinsed substrate with a second supercritical carbon dioxide cleaning solution containing an organic solvent and an acid containing fluorine atoms.

15. The method according to claim 14, wherein the second supercritical carbon dioxide cleaning solution comprises dimethyl acetamide and pyridine-HF.

16. The method according to claim 1, further comprising, prior to treating the substrate with a supercritical carbon dioxide cleaning solution:
pre-treating the substrate with an ozone processing environment.

17. The method according to claim 16, wherein the pre-treating comprises maintaining a process pressure of between about 5 psig and about 100 psig.

18. The method according to claim 16, wherein the pre-treating comprises maintaining a process pressure between about 15 psig and about 40 psig.

19. The method according to claim 16, wherein the pre-treating comprises maintaining the substrate at a temperature between about 20° C. and about 400° C.

20. The method according to claim 16, wherein the pre-treating comprises exposing the substrate to the ozone processing environment for a time period between about 60 sec and about 300 sec.

21. The method according to claim 16, wherein the treating is performed in a supercritical fluid processing system and the pre-treating is performed in an ozone processing system operatively coupled to the supercritical fluid processing system.

22. The method according to claim 16, wherein both the pre-treating and the treating are performed in a supercritical fluid processing system.

23. A method of cleaning a substrate in a film removal system, the method comprising:
providing a substrate in a process chamber, the substrate containing a micro-feature having a residue thereon;
generating ozone in the process chamber;
forming a supercritical carbon dioxide cleaning solution containing a supercritical carbon dioxide, a peroxide, and ozone in the process chamber; and
treating the substrate with the supercritical carbon dioxide cleaning solution to remove the residue from the micro-feature, where the supercritical carbon dioxide cleaning solution is maintained at a temperature between about 35° C. and about 80° C.

24. The method according to claim 23, wherein the residue comprises a post-etch residue.

25. The method according to claim 24, wherein the post-etch residue comprises photoresist remnants and etch residues.

26. The method according to claim 23, wherein the micro-feature comprises a porous dielectric layer, a carbon-containing dielectric layer, or an ultra-low-k dielectric layer, or a combination of two or more thereof.

27. The method according to claim 26, wherein the carbon-containing dielectric layer comprises a SiCOH layer.

28. The method according to claim 23, wherein the generating comprises forming an ozone processing environment having a process pressure of between about 5 psig and about 100 psig.

29. The method according to claim 23, wherein the generating comprises forming an ozone processing environment having a process pressure between about 15 psig and about 40 psig.

30. The method according to claim 23, wherein the supercritical carbon dioxide cleaning solution is maintained at a temperature between about 60° C. and about 70° C.

31. The method according to claim 23, wherein the peroxide comprises hydrogen peroxide or an organic peroxide.

32. The method according to claim 31, wherein the organic peroxide comprises 2-butanone peroxide, 2,4-pentanedione peroxide, peroxyacetic acid, benzoyl peroxide, t-butyl hydroperoxide, or m-chloroperbenzoic acid, or a combination of two or more thereof.

33. The method according to claim 23, wherein the supercritical carbon dioxide cleaning solution further comprises an acid.

34. The method according to claim 33, wherein the acid comprises hydrogen fluoride, trifluoroacidic acid, pyridine-hydrogen fluoride, ammonium fluoride, nitric acid, or phosphoric acid, or a combination of two or more thereof.

35. The method according to claim 23, further comprising rinsing the treated substrate with a supercritical carbon dioxide rinsing solution containing an organic solvent.

36. The method according to claim 35, wherein the organic solvent comprises an alcohol, a ketone, or a combination of both.

37. The method according to claim 35, wherein the organic solvent comprises methanol, ethanol, n-propanol, isopropanol, benzyl alcohol, acetone, butylene carbonate, propylene carbonate, dimethylsulfoxide, γ-butyrolactone, dimethyl formamide, dimethyl acetamide, or ethyl lactate, or a combination of two or more thereof.

38. The method according to claim 35, further comprising treating the rinsed substrate to second supercritical carbon dioxide cleaning solution containing an organic solvent and an acid containing fluorine atoms.

39. The method according to claim 38, wherein the second supercritical carbon dioxide cleaning solution comprises dimethyl acetamide and pyridine-HF.
